(19) United States
(12) Patent Application Publication
(10) Pub. No.: US 2020/0176167 A1
(43) Pub. Date: Jun. 4, 2020

(54) DEVICE FOR PREPARING SMALL MOLECULE WATER

(71) Applicant: QUALITY PURE CO., LTD., Taipei City (TW)

(72) Inventor: GUAN-HAO CHEN, TAIPEI CITY (TW)

(21) Appl. No.: 16/356,704

(22) Filed: Mar. 18, 2019

Related U.S. Application Data
(60) Provisional application No. 62/775,082, filed on Dec. 4, 2018.

(51) Int. Cl. H01F 27/02; H01F 27/28

(52) U.S. Cl. CPC H01F 27/027; C02F 1/48; H01F 27/28

(57) ABSTRACT

The present invention relates to a device for preparing small molecular water and a dishwasher comprising the same. The device comprises a spiral tube, a metal coil, a hollow cylindrical housing and a circuit board. The spiral tube comprises a spiral tubular body with two ends extending to form a water inlet channel and a water outlet channel. The metal coil defines a first accommodating space to hold the spiral tube. The hollow cylindrical housing defines a second accommodating space inside for the spiral tube and the metal coil assembled in the second accommodating space, and a plurality of magnetic elements are annularly arranged outside the hollow cylindrical housing. The circuit board electrically connected to the metal coil and is capable of controlling water intake and water discharge of the device. Thus, water molecules is magnetized to be transformed into small molecular water cluster and is utilized more efficiently.

### FIELD OF THE INVENTION

The present invention relates to a magnetizer, more particularly to a magnetizer for magnetizing water.

### BACKGROUND OF THE INVENTION

Water is one of the most common and most important substances on the earth, which not only constitutes living organisms, but also is relied on to live by all things.

Due to the fact that water is important, people started to be aware of water long before, and tried to change the properties of water with the use thereof, so as to improve the utilization efficiency of water by reducing the molecular group of the water.

For example, the human has found that natural water produced in the place with stronger terrestrial magnetic force or rich iron ores would be magnetized to enhance the permeability and dissolubility, comparing with the unmagnetized natural water. Given this, the human tried to magnetize water in an artificial manner. At present, this method has been extensively applied in the aspects of industry, agriculture and health care. The Magnetized water is significantly improved in permeability of dissolved oxygen amount, enzyme activity and biological membrane after researching. Thus, it is believed that the magnetized water is helpful to improve the function of the human.

However, although a lot of research teams have put forward ideas about a device for magnetizing water at present, such device still needs to be improved in aspects of structure and ability to magnetize water. Therefore, there is a very urgent need to propose further researches and improvements by those skilled in the relevant art.

### SUMMARY OF THE INVENTION

An objective of the present invention is to solve the problem that an existing device for magnetizing water does not meet the modern industrial requirements in structure and ability to magnetize water.

Another objective of the present invention is to provide a dishwasher comprising a device which is capable of magnetizing water, so as to reduce the consumption of washing water and detergent as well as improve the effect on dish cleaning rate.

To achieve the above objectives, the present invention provides a device for preparing small molecular water including: a spiral tube includes a spiral tubular body, a water inlet channel which is extending from the spiral tubular body in a first direction, and a water outlet channel which is extending in the first direction and being parallel to the water inlet channel, wherein a height of the spiral tube is ranged from 100 mm to 130 mm; a metal coil includes a cylindrical mold and at least one metal wire wound around the cylindrical mold in 165 to 205 turns, wherein the cylindrical mold defines a first accommodating space inwardly for the spiral tube assembled in the first accommodating space; a hollow cylindrical housing defines a second accommodating space inside for the spiral tube and the metal coil assembled in the second accommodating space, and includes a plurality of magnetic elements disposed outside and arranged annularly; and a circuit board is electrically connected to the metal coil.

In an embodiment, the spiral tube is made of metal.

In an embodiment, the spiral tube is made of stainless steel.

In an embodiment, a length of the spiral tube is ranged from 95 cm to 125 cm if the spiral tube is straightened.

In an embodiment, the spiral tubular body satisfies at least one of following (1) to (3): (1) a height (H1) of the spiral tubular body is ranged from 65 mm to 80 mm; (2) a width (D1) of the spiral tubular body is ranged from 48 mm to 58 mm; and (3) a height (H2) of the water inlet channel and a height (H2) of the water outlet channel protruding from an end of the spiral tubular body may be identical or different, independently ranging from 35 mm and 50 mm.

In an embodiment, internal diameters of the water inlet channel and the water outlet channel may be identical or different, and independently ranging from 7 mm to 8.5 mm.

In an embodiment, outer diameters of the water inlet channel and the water outlet channel may be identical or different, independently ranging from 8.5 mm to 10.5 mm.

In an embodiment, the cylindrical mold satisfies at least one of following (1) to (3): (1) a internal diameter (D3) of the cylindrical mold is ranged from 65 mm to 80 mm; (2) a width (D2) of the first accommodating space is ranged from 60 mm to 75 mm; and (3) a height (H3) of the cylindrical mold is ranged from 77 mm to 95 mm.

In an embodiment, the at least one metal wire is a copper wire with a wire-width ranged from 0.2 mm to 0.26 mm.

In an embodiment, a length of each metal wire is ranged from 3500 cm to 4500 cm.

In an embodiment, the hollow cylindrical housing satisfies at least one of following (1) to (2): (1) a width (D5) of the second accommodating space is arranged from 60 mm to 80 mm; and (2) a height (H4) of the hollow cylindrical housing is arranged from 85 mm to 105 mm.

In an embodiment, a number of the plurality of magnetic elements is ranged from 3 to 20, and the plurality of magnetic elements are spaced a predetermined distance from each other and annularly arranged on the hollow cylindrical housing.

In an embodiment, each of the magnets includes a length ranging from 50 mm to 65 mm and a width ranging from 10 mm to 15 mm.

In an embodiment, the circuit board is integrated on a rectangular substrate which comprises a length ranging from 50 mm to 65 mm and a width ranging from 80 mm to 105 mm.

The present invention further provides a dishwasher including a pre-washing module, a main washing module, a rinsing module, and a conveyor belt allowing an uncleaned object to pass through the pre-washing module, the main washing module and the rinsing module in sequence, wherein the pre-washing module comprises a device for preparing small molecular water as described above to provide small molecular water for flushing the uncleaned object.

Thus, the present invention magnetizes water by using the device for preparing small molecular water which is comprising a magnetic unit of a specific size, such that the full-width at half maximum (FWHM) of molecules in water cluster is significantly reduced about 45% to 65% in comparison with the unmagnetized water, and amount of the dissolved oxygen is increased about 1.5 to 2.5 times in comparison with the unmagnetized water. As a result, the utilization efficiency of water is improved. Especially applied to a dishwasher, since water molecular is reduced in structure and decreased in surface tension after magnetized, the consumption of washing water and detergent is effectively saved. Accordingly, the dish cleaning rate is increased.

### BRIEF DESCRIPTION OF THE DRAWINGS

FIG. 1 is a schematic diagram of a device for preparing small molecular water according to an embodiment of the present invention;

FIG. 2 and FIG. 3 are schematic diagrams of a spiral tube according to an embodiment of the present invention;

FIG. 4 and FIG. 5 are schematic diagrams of a hollow cylindrical housing according to an embodiment of the present invention; and

FIG. 6 is a schematic diagram of a dishwasher provided with a device for preparing small molecular water according to an embodiment of the present invention.

### DETAILED DESCRIPTION OF THE PREFERRED EMBODIMENTS

The detailed descriptions and the technical contents of the present invention are presented below in conjunction with the drawings.

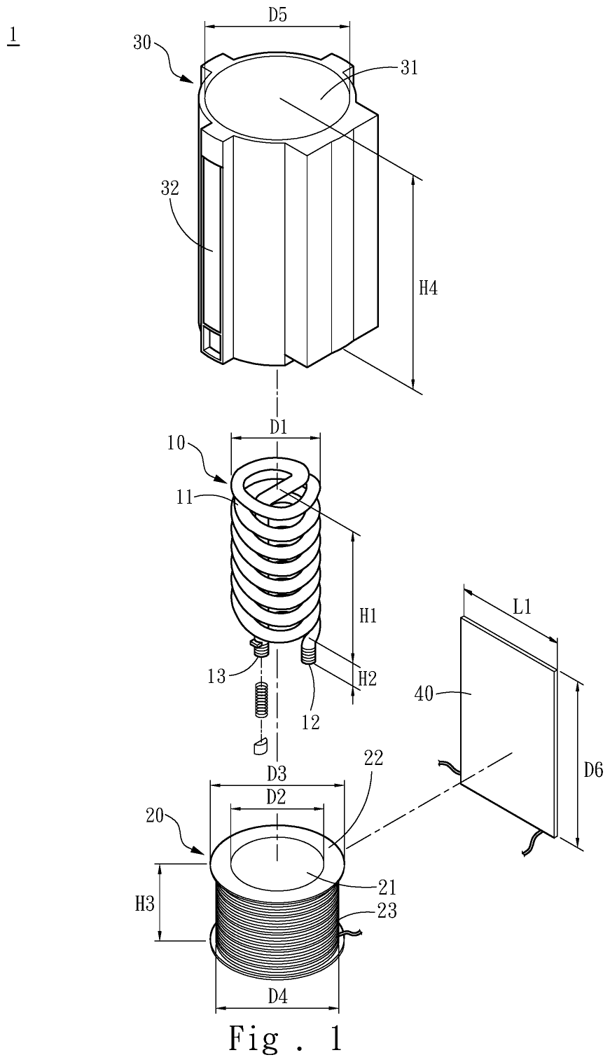

FIG. 1 is a schematic diagram of a device for preparing small molecular water 1 which mainly includes a spiral tube 10, a metal coil 20, a hollow cylindrical housing 30, and a circuit board 40.

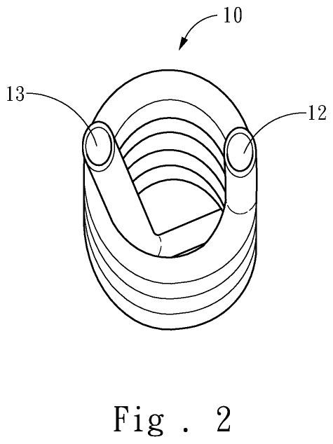

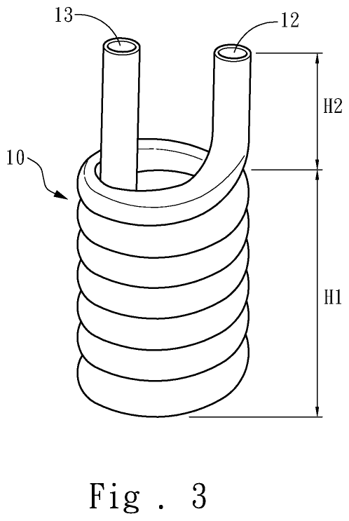

Referring to FIG. 2 and FIG. 3, the spiral tube 10 with a height ranging from 100 mm to 130 mm is made by twisting a metal tube, such as a stainless tube, with a length ranging from 95 cm to 125 cm. In one embodiment of the present invention, a stainless steel tube with a length of 110 cm is selected and twisted into a spiral tube 10 with a height of 116 mm.

The spiral tube 10 comprises a spiral tubular body 11 that encloses a space inwardly. One of the two ends of the metal tube extends in a first direction, and the other end is bent inwardly to the spiral tubular body 11 at 90 degrees, cross a bottom of the space of the spiral tubular body 11, bent 90 degrees and extended in the first direction along an inner wall of the space of the spiral tubular body 11 (as shown in FIG. 2). Accordingly, the two ends of the metal tube are extending in parallel in the first direction to be a water inlet channel 12 and a water outlet channel 13 respectively. However, in other embodiments of the present invention, the positions of the water inlet channel 12 and the water outlet channel 13 may be mutually exchanged, and the present invention is not limited thereto.

The spiral tube 10 is now described in more detail. In this embodiment, a height H1 of the spiral tubular body 11 forming the spiral tube 10 is in a range of 65 mm to 80 mm, such as 73 mm, and a width D1 of the spiral tubular body 11 is in a range of 48 mm to 58 mm, such as 53 mm.

The heights of the water inlet channel 12 and the water outlet channel 13 would be identical or different. In the embodiment, take the one end of the spiral tube 10 as a baseline, the water inlet channel 12 and the water outlet channel 13 protruding from the end of the spiral tube 10 have a same height H2 which is in a range of 35 mm to 50 mm, such as 43 mm. In addition, each of the water inlet channel 12 and the water outlet channel 13 comprises an internal diameter in a range of 7 mm to 8.5 mm, such as 7.7 mm, and an internal diameter in a range of 8.5 mm to 10.5 mm, such as 9.4 mm.

Referring to FIG. 1, the metal coil 20 includes a cylindrical mold 22 and at least one metal wire 23 wound around the cylindrical mold 22. The cylindrical mold 22 defines a first accommodating space 21 inwardly. The cylindrical mold 22 is made of plastics, and comprises an internal diameter D3 ranging from 65 mm to 80 mm, and a height H3 ranging from 77 mm to 95 mm. For example, the internal diameter D3 is 70 mm, and the height H3 is 86 mm. Further, a width D2 of the first accommodating space 21 is in a range of 60 mm to 75 mm, such as 67 mm, so that the spiral tube 10 can be assembled in the first accommodating space 21.

In one embodiment, each of the metal wires 23 is a copper wire with a wire-width ranged from 0.2 mm to 0.26 mm. Therefore, the metal coil 20 is formed by winding the at least one metal wire 23 around the cylindrical mold 22 for 165 to 205 turns. Alternatively, in another embodiment, to take six copper wires with each length about 3500 cm to 4500 cm thereof as an example, each of six copper wires is wound 185 turns around the cylindrical mold 22 to form the metal coil 20. Thus, a total width D4 of the metal coil 20 including the metal wires 23 is about 73 mm after all the metal wires 23 are wound.

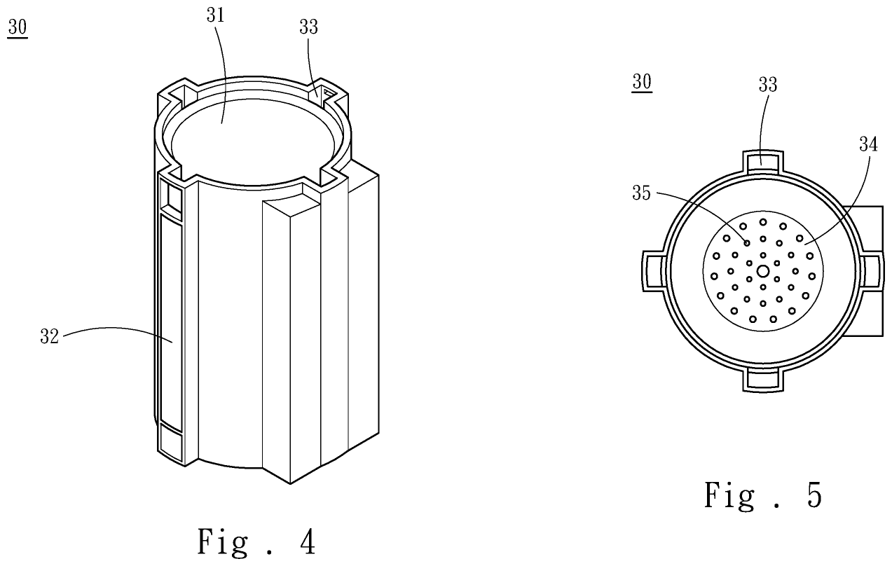

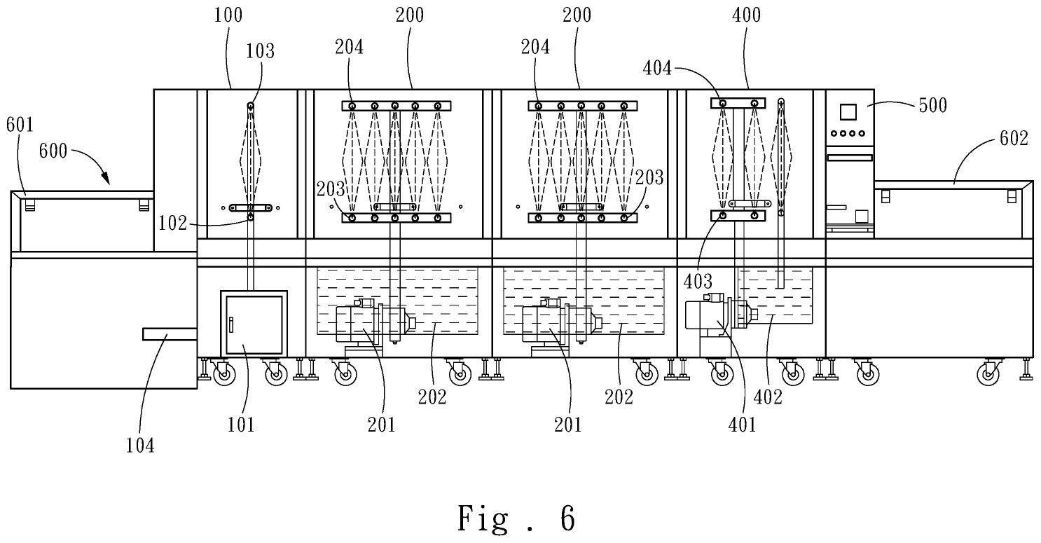

Referring to FIG. 4 and FIG. 5, a second accommodating space 31 is defined by inner wall of the hollow cylindrical housing 30, such that the spiral tube 10 and the metal coil 20 are assembled together in the second accommodating space 31.

A width D5 of the second accommodating space 31 of the hollow cylindrical housing 30 is in a range of 60 mm to 80 mm, such as 72 mm, and a height H4 of the hollow cylindrical housing is in a range of 85 mm to 105 mm, such as 95 mm.

Furthermore, a plurality of magnetic elements 32 is annularly arranged on the hollow cylindrical housing 30. In this embodiment, the plurality of magnetic elements 32 is selected form magnets, and any two of the plurality of magnetic elements 32 are spaced in a predetermined distance. To take four magnets as an example, four magnets are disposed on a protruding portion 33 at the outside of the hollow cylindrical housing 30 and spaced at the same distance from each other. The length of each of four magnets is ranged between 50 mm and 65 mm (such as 57 mm), and the width of each of four magnets is in a range of 10 mm and 15 mm, such as 13 mm. There is no limitation on a number of the magnetic members 32, and the number of the magnetic members 32 is ranged from 3 and 20.

A bottom 34 of the hollow cylindrical housing 30 further includes a plurality of through holes 35 for dissipating heat.

Referring to FIG. 1, the circuit board 40 is electrically connected to the metal coil 20. In the embodiment, the circuit board is integrated on a rectangular substrate with a length L1 in a range of 50 mm to 65 mm and a width D6 in a range of 80 mm to 105 mm. For example, the length L1 is 56 mm and the width D6 is 94 mm.

In the embodiment, ¹⁷O is tested by 500 MHz nuclear magnetic resonance (NMR) at 25° C. In the embodiment, it shows that the full-width at half maximum (FWHM) of water molecules in water cluster is about 113.5 Hz before magnetized by a device for preparing small molecular water 1 with the structure described above. Then, the full-width at half maximum (FWHM) of water molecules is cut to be about 67.2 Hz after passing through the device for preparing small molecular water 1. In addition, dissolved oxygen is tested by a common method of iodometric analysis. In the embodiment, it shows amount of the dissolved oxygen is increased from 4.0 mg/l to 8.0 mg/l after the water is magnetized by the device for preparing small molecular water 101.

The present invention further provides a dishwasher which includes the device for preparing small molecular water described above.

Referring to FIG. 6, the dishwasher includes a pre-washing module 100, a main washing module 200, a rinsing module 400, and a conveyor belt 600, which allows an uncleaned object passing through the pre-washing module 100, the main washing module 200, and the rinsing module 400 in sequence. The conveyor belt 600 comprises an inlet 601 close to the pre-washing module 100 and an outlet 602 close to the rinsing module 400. In addition, a control module 500 is further disposed at the outlet 602, allowing a user to control the operation of the dishwasher.

The pre-washing module 100 includes a device for preparing small molecular water 101 to flush the uncleaned object. The device for preparing small molecular water 101 is connected to a water outlet pipe. At least a pair of nozzles 102, 103 spaced by a predetermined distance is arranged on the water outlet pipe. When the uncleaned object enters the pre-washing module 100 via the conveyor belt 600, water without detergent is injected into the device for preparing small molecular water 101 via a wash port 104 which is used for both injecting and discharging water. Then the water magnetized by the device for preparing small molecular water 101 as a cleaning water is ejected to spray the uncleaned object under high pressure for a predetermined period of time to complete a pre-washing procedure. The structure of the device for preparing small molecular water 101 included in the pre-washing module 100 is as described above, and will not be further described redundantly herein.

Then, the uncleaned object enters the main washing module 200 after passing through the pre-washing module 100. The main washing module 200 includes a high-pressure water pump 201 disposed under a water tank 202, whereby the cleaning water without the detergent is ejected via a plurality of nozzles 203, 204 correspondingly arranged on a water outlet pipe and circulated in a working tank of the pre-washing module 100. Moreover, another main washing module 200 is also be added as required, which is not limited in the present invention.

The uncleaned object t enters the rinsing module 400 along with the conveyor belt 600 after being cleaned by the main washing module 200. The rinsing module 400 includes a high-pressure water pump 401 disposed under a water tank 402, whereby the cleaning water without the detergent in the water tank 402 is ejected via a plurality of nozzles 403, 404 arranged on a water outlet pipe for rinsing.

In the above embodiment, the cleaning water circulated in the pre-washing module 100, the main washing module 200 and the rinsing module 400 basically has no difference, and which is small-molecular water treated by the device for preparing small molecular water 101 and conveyed to the water tanks 202 and 402 via an internal pipe (not shown) to serve as the cleaning water.

Subsequently, the cleaned object is conveyed to a retrieving platform via the outlet 602 to complete a cleaning procedure.

What is claimed is:

1. A device for preparing small molecular water, comprising:
a spiral tube including a spiral tubular body, a water inlet channel extending from the spiral tubular body in a first direction and a water outlet channel extending in the first direction and being parallel to the water inlet channel, wherein a height of the spiral tube is ranged from 100 mm to 130 mm;
a metal coil including a cylindrical mold and at least one metal wire wound around the cylindrical mold in 165 to 205 turns, wherein the cylindrical mold defines a first accommodating space inwardly for the spiral tube assembled in the first accommodating space;
a hollow cylindrical housing defining a second accommodating space inside for the spiral tube and the metal coil assembled in the second accommodating space, and including a plurality of magnetic elements disposed outside and arranged annularly; and
a circuit board electrically connected to the metal coil.

2. The device for preparing small molecular water of claim 1, wherein the spiral tube is made of metal.

3. The device for preparing small molecular water of claim 1, wherein the spiral tube is made of stainless steel.

4. The device for preparing small molecular water of claim 1, wherein the spiral tubular body satisfies at least one of following (1) to (3):
(1) a height (H1) of the spiral tubular body is ranged from 65 mm to 80 mm;
(2) a width (D1) of the spiral tubular body is ranged from 48 mm to 58 mm; and
(3) a height (H2) of the water inlet channel and a height (H2) of the water outlet channel protruding from an end of the spiral tubular body are identical or different, independently ranging from 35 mm and 50 mm.

5. The device for preparing small molecular water of claim 1, wherein the cylindrical mold satisfies at least one of following (1) to (3):
(1) a internal diameter (D3) of the cylindrical mold is ranged from 65 mm to 80 mm;
(2) a width (D2) of the first accommodating space is ranged from 60 mm to 75 mm; and
(3) a height (H3) of the cylindrical mold is ranged from 77 mm to 95 mm.

6. The device for preparing small molecular water of claim 1, wherein the at least one metal wire is a copper wire with a wire-width ranged from 0.2 mm to 0.26 mm.

7. The device for preparing small molecular water of claim 1, wherein the hollow cylindrical housing satisfies at least one of following (1) to (2):
(1) a width (D5) of the second accommodating space is arranged from 60 mm to 80 mm; and
(2) a height (H4) of the hollow cylindrical housing is arranged from 85 mm to 105 mm.

8. The device for preparing small molecular water of claim 1, wherein a number of the plurality of magnetic elements is ranged from 3 to 20, and the plurality of magnetic elements are spaced a predetermined distance from each other and annularly arranged on the hollow cylindrical housing.

9. The device for preparing small molecular water of claim 8, wherein each of the plurality of magnets includes a length ranging from 50 mm to 65 mm and a width ranging from 10 mm to 15 mm.
